(19) United States
(12) Patent Application Publication
(10) Pub. No.: US 2026/0102709 A1
(43) Pub. Date: Apr. 16, 2026

(54) CHARACTER MANAGEMENT SYSTEM, CHARACTER MANAGEMENT METHOD, AND METHOD FOR PROVIDING CHARACTER INFORMATION

(71) Applicant: BANDAI NAMCO Entertainment Inc., Tokyo (JP)

(72) Inventor: Zhantao LAI, Kawasaki-City (JP)

(73) Assignee: BANDAI NAMCO Entertainment Inc., Tokyo (JP)

(21) Appl. No.: 19/116,075

(22) PCT Filed: Sep. 26, 2023
(86) PCT No.: PCT/JP2023/034919

§ 371 Date: Mar. 27, 2025

(30) Foreign Application Priority Data
Sep. 30, 2022 (JP) 2022-158803

(51) Int. Cl. A63F 13/63; A63F 13/533; A63F 13/79

(52) U.S. Cl. CPC A63F 13/63; A63F 13/533; A63F 13/79

(57) ABSTRACT

A character management system that can create the player character that accurately reflects the preference of the player while eliminating the complexity of creating the player character. The server device has a configuration for: executing a composing element determination process for determining a composing element to be changed from among composing elements of a base character on the basis of player-related information that has already stored or player input information inputted by the player; and a modified character creation process for creating a modified character in which composing elements are modified from the base character on the basis of the determined composing element. The server has a configuration capable of creating a character which can be used in a game or the like and accurately reflects the preference of the user while eliminating the complexity of creating a character by using the base character.

### TECHNICAL FIELD

The present invention relates to a character management system, a character management method, a character information providing method, and the like.

### BACKGROUND ART

In recent years, it has become common to create a character of a user's preference and to make the character appear in a virtual space such as a game to enjoy the game.

In addition, recently, it has become widespread to create a character as an avatar in place of a user, and to operate the avatar to express a user's intention or act as the user's alter ego in a virtual space in addition to a game, thereby communicating with other users.

On the other hand, in recent years, a system for automatically creating a character only by a simple instruction of the user has been developed because creation of the character such as an avatar is complicated (for example, Japanese Patent Application No. 2019-211820).

### SUMMARY OF THE INVENTION

### Problem to be Solved by the Invention

However, in the information processing system disclosed in Japanese Patent Application No. 2019-211820, it is sometimes difficult to create the character that matches the user's preference, although the character is automatically created according to the user's instruction.

The present invention provides a character management system capable of creating a character which accurately reflects a user's preference while resolving the complexity of creating a character, and the like.

### Solution to the Problem

(1) To achieve the relevant objective, the character management system according to a second aspect of the present invention is a character management system for managing a character used in a virtual space, and the character management system has:
a management unit to manage, as base character information, information of a base character whose composing elements are changeable, and which is stored in a storage unit for managing a character;
a management unit to manage, as base character information, information of a base character whose composing elements are changeable, and which is stored in a storage unit for managing a character;
an acquisition unit to acquire user related information regarding a user or user input information including at least one of text information, image information, and voice information that are input by the user, the user related information having been already stored in a storage unit for user management;
a composing element determination unit to determine, based on an acquired user related information or an acquired user input information, the content of the composing element of the base character, a composing element to be changed from among the composing elements of the base character, or a composing element to be added to the base character;
a modified character creation unit to execute a modified character creation process of creating a modified character in which the composing element is modified from the base character based on the content of the determined composing element, the composing element to be modified, or the composing elements to be added.

(2) To achieve the relevant objective, the character management system according to a second aspect of the present invention is a character management system for managing a character used in a virtual space, and the character management system has:
a management unit to manage, as base character information, information of a base character whose composing elements are changeable, and which is stored in a storage unit for managing a character;
an acquisition unit to acquire user related information regarding a user, the user related information having been already stored in a storage unit for user management;
a modified character creation unit to execute a modified character creation process of creating a plurality of modified characters in which the composing element is modified from the base character based on an acquired user related information; and
a presentation unit to present to the player information of a created modified character as modified character information.

(3) To achieve the relevant objective, the character management system according to a second aspect of the present invention is a character management method for managing a character used in a virtual space, and the character management method has:
managing, as base character information, information of a base character whose composing elements are changeable, and which is stored in a storage unit for managing a character;
acquiring user related information regarding a user or user input information including at least one of text information, image information, and voice information that are input by the user, the user related information having been already stored in a storage unit for user management;
determining, based on an acquired user related information or an acquired user input information, the content of the composing element of the base character, a composing element to be changed from among the composing elements of the base character, or a composing element to be added to the base character;
executing a modified character creation process of creating a modified character in which the composing element is modified from the base character based on the content of the determined composing element, the composing element to be modified, or the composing elements to be added.

(4) To achieve the relevant objective, the character management system according to a second aspect of the present invention is a character management method for managing a character used in a virtual space, and the character management method has:
managing, as base character information, information of a base character whose composing elements are changeable, and which is stored in a storage unit for managing a character;
acquiring user related information regarding a user, the user related information having been already stored in a storage unit for user management;
executing a modified character creation process of creating a plurality of modified characters in which the composing element is modified from the base character based on an acquired user related information; and
presenting to the player information of a created modified character as modified character information, (5) To achieve the relevant objective, the character information providing method
according to a fifth aspect of the present invention is a character information providing method for providing information of a character to a terminal device from a server that executes a modified character registration creation process including a modified character registration creation process for a modified character indicating a modified character used in a virtual space, having:
the server having:
   a management unit to manage, as base character information, information of a base character whose composing elements are changeable, and which is stored in a storage unit for managing a character;
   an acquisition unit to acquire user related information regarding a user or user input information including at least one of text information, image information, and voice information that are input by the user, the user related information having been already stored in a storage unit for user management;
   a composing element determination unit to determine, based on an acquired user related information or an acquired user input information, the content of the composing element of the base character, a composing element to be changed from among the composing elements of the base character, or a composing element to be added to the base character;
   a modified character creation unit to execute a modified character creation process of creating a modified character in which the composing element is modified from the base character based on the content of the determined composing element, the composing element to be modified, or the composing elements to be added,
wherein information of the operation of the user received by the terminal device is transmitted to the server device; and
the character information is received from the server.

To achieve the relevant objective, the character information providing method
according to a fifth aspect of the present invention is a character information providing method for providing information of a character to a terminal device from a server that executes a modified character registration creation process including a modified character registration creation process for a modified character indicating a modified character used in a virtual space, having:
the server having:
   a management unit to manage, as base character information, information of a base character whose composing elements are changeable, and which is stored in a storage unit for managing a character;
   an acquisition unit to acquire user related information regarding a user, the user related information having been already stored in a storage unit for user management;
   a modified character creation unit to execute a modified character creation process of creating a plurality of modified characters in which the composing element is modified from the base character based on an acquired user related information; and
   a presentation unit to present to the player information of a created modified character as modified character information.
wherein information of the operation of the user received by the terminal device is transmitted to the server device; and
the character information is received from the server.

### BRIEF DESCRIPTION OF DRAWINGS

FIG. 1 is an example of a network diagram illustrating a game system according to one embodiment of the present invention.

FIG. 2 is an example of a functional block diagram illustrating a server according to one embodiment of the present invention.

FIG. 3 is an example of a functional block diagram illustrating a terminal device according to one embodiment of the present invention.

FIG. 4 is a diagram for explaining a modified character creation and registration process executed by the server of the one embodiment of the present invention.

FIG. 5 is a diagram illustrating an example of player-related information stored in a player information storage unit according to an embodiment of the present invention.

FIG. 6 is a diagram illustrating an example of modified character information stored in a character information storage unit in the embodiment of the present invention.

FIG. 7 is a diagram illustrating an example of base character information stored in a player information storage unit according to an embodiment of the present invention.

FIG. 8 is a diagram for explaining a character modification process executed by the server according to an embodiment of the present invention.

FIG. 9 is a flowchart illustrating the operation of the modified character creation and registration process executed by the server according to one embodiment of the present invention.

### DETAILED DESCRIPTION OF THE EMBODIMENT

(1) In an embodiment of the present invention, the character management system for managing a character used in a virtual space, has:
a management unit to manage, as base character information, information of a base character whose composing elements are changeable, and which is stored in a storage unit for managing a character;
an acquisition unit to acquire user related information regarding a user or user input information including at least one of text information, image information, and voice information that are input by the user, the user related information having been already stored in a storage unit for user management;
a composing element determination unit to determine, based on an acquired user related information or an acquired user input information, the content of the composing element of the base character, a composing element to be changed from among the composing elements of the base character, or a composing element to be added to the base character;
a modified character creation unit to execute a modified character creation process of creating a modified character in which the composing element is modified from the base character based on the content of the determined composing element, the composing element to be modified, or the composing elements to be added.

Based on this configuration, the one embodiment of the present invention can create the modified character in which the composing elements of the base character are changed based on the information of a user assumed to reflect the preference of the user such as a player or the information inputted by the user himself/herself, and can create the modified character only by the information already stored or the inputted information.

Accordingly, the one embodiment of the present invention can create the player character that accurately reflects the preference of the player while eliminating the complexity of creating the player character.

The “management of characters” is managing the base character and the modified character for each user, and the use in a virtual space such as a game or metaverse.

The “composing elements” include elements that create the character, such as:
(A1) appearance of the character (hair style, eyes, mouth, nose, hands and feet, body, skin color, etc.);
(A2) equipment (such as weapons) or accessories (such as glasses, hats, or accessories) worn by the character; and
(A3) voice.

The “base character” indicates a character in which each of the above-described components is set in advance by the user or a system administrator.

The “user-related information” includes, for example:
(B1) information r (hereinafter referred to as a “character history information”) regarding the character that was involved by the user in the past. For example, the character (hereinafter referred to as a “user character”) was used by the user in the virtual space such as the game or the metaverse, and the character had a relationship with the user such as the character that has contacted the user character and the character that has attracted attention by the user;
(B2) information (hereinafter referred to as “virtual space history information”) regarding the virtual space in which the user character existed in the past; and
(B3) information regarding another user related to the user, such as a friend user that the user is interacting in the virtual space and an opponent user, or information regarding a character possessed by the other user.

Specifically, the information of (B1) to (B3) includes image information relating to an image of the character or the virtual space such as color, decoration, or sound of elements constituting the character or the virtual space.

The “user input information” includes information input by the user using an input device such as a keyboard, a tablet, or a voice, and includes, for example, image information and voice information in addition to text information.

(2) In an embodiment of the present invention, the character management system for managing a character used in a virtual space, has:
a management unit to manage, as base character information, information of a base character whose composing elements are changeable, and which is stored in a storage unit for managing a character;
an acquisition unit to acquire user related information regarding a user, the user related information having been already stored in a storage unit for user management; a modified character creation unit to execute a modified character creation process of creating a plurality of modified characters in which the composing element is modified from the base character based on an acquired user related information; and a presentation unit to present to the player information of a created modified character as modified character information.

Based on this configuration, the one embodiment of the present invention can create the modified character in which the composing elements of the base character are changed based on the information of a user assumed to reflect the preference of the user such as a player, and can create the modified character only by the information already stored.

Accordingly, the one embodiment of the present invention can create the player character that accurately reflects the preference of the player while eliminating the complexity of creating the player character.

(3) In an embodiment of the present invention, the character management system has
a selection unit to select one or more the modified characters by the user from among the plurality of modified characters.

Based on this configuration, the one embodiment of the present invention can more reliably acquire a modified character that matches the user's preference.

(4) In an embodiment of the present invention, the character management system has
related character history information that is information of a character, which was involved in the past, by the user or that is information of a user character owned by another user related to the user; or virtual space history information relating to a virtual space in which the user character has existed in the past.

Based on this configuration, the one embodiment of the present invention can create the modified character based on the character (that is, the user character) that the user was used in the past in a game or the like, the virtual space in which the character exists, or information of another user that is connected in the virtual space.

For example, the one embodiment of the present invention can modify composing elements (i.e., color, shape, sound effects, etc.) of the user's base character based on the composing elements of the character, such as the color, shape, or sound effects (including voice) of a decoration or a tool owned by the character that was involved to the user character used by the user, the color, shape, or sound effects.

For example, the one embodiment of the present invention can modify the composing elements (i.e., color, shape, sound effects, etc.) of the user's base character based on the composing elements of the characters of other users related to the user, such as the characters of the user's friends or other users accessing the same virtual space during the same period.

Furthermore, for example, the one embodiment of the present invention can modify the composing elements (i.e., color, shape, sound effects, etc.) of the user's base character based on information regarding the virtual space in which the user character existed in the past.

Accordingly, the one embodiment of the present invention can create a character that accurately reflects the user's taste or interest, or a character that is attached to the user.

The “character history information” includes information of a composing element of the character or information of characteristic of a composing element (such as a color, shape, or sound) of the character, such as:
(C1) information of the user character that was used by the user in the past;
(C2) information of the character that contacts the user character, such as a character that was played for a given task cooperatively as an opponent character or a character with whom to speak);
(C3) information of a character that performs a performance such as an acting or singing, which is gazed by the user;
(C4) information regarding another user character of another user having a given relationship such as a friend of the user through a virtual space; and
(C5) information of a character assumed to have the same tendency as the player, such as a character of another user who has accessed the same virtual space in the same period as the player.

The “virtual space history information” includes, for example, information of a composing element of the virtual space or information of a characteristic (color, shape, or sound) of the composing element, the composing element of the virtual space including a spatial composing element (color, decoration, or sound) of the virtual space in which the characters existed in the past, the characters being the user character or the character having a given relationship with the user in the past.

Specifically, the composing element includes, for example, the appearance of the character (for example, clothing and equipment), color information of the virtual space, or a theme set in the virtual space.

(5) In an embodiment of the present invention, the character management system has
the user input information that includes information of an appearance or a personality of the modified character.

Based on this configuration, the one embodiment of the present invention can create the character that accurately reflects the user's preference because acquiring the information of a character desired by the user and creating the modified character based on acquired the information.

The “appearance information” and the “character information” include, for example, text, image, and sound information for specifying the appearance or the character.

(6) In an embodiment of the present invention, the character management system has
the character model generation unit to execute model data generation process to generate, as model data, a modified character model based on training data including the input user related information or user input information and a character model corresponding to the user related information or the user input information,
wherein the modified character creation process unit executes the modified character creation process of creating the modified character based on the input user related information or player input information by using the generated model data.

Based on this configuration, the one embodiment of the present invention can automatically create the more suitable modified character while updating the character model based on the input user related information or the user input information used as the training data.

(7) In an embodiment of the present invention, the character management system has
the modified character creation process unit that determines the composing element to be modified based on a given instruct, and executes the modification of a determined composing element.

Based on this configuration, the one embodiment of the present invention can create the modified character that accurately reflects the user's preference because the modifications of the composing element of the base character can be pinpointed.

The “given instruction” includes an instruction of the user and an instruction by a system such as a program.

(8) In an embodiment of the present invention, the character management system has
an event detecting unit to detect occurrence of a given event; and
an arrangement control unit to arrange the modified character in place of the character in use on the basis of the registered modified character information when the occurrence of the event is detected.

Based on this configuration, the one embodiment of the present invention can use, when a battle event of a game or the like is executed, a character specialized in a battle, and therefore, the user's interest in the character can be improved.

The “given event” includes an event related to a game, an event related to a performance during viewing of contents, and an event such as contact of other users in the metaverse.

(9) In an embodiment of the present invention, the character management system has
a condition detecting unit to detect a given condition; and
an arrangement control unit to arrange the modified character in place of the character in use on the basis of the registered modified character information when the condition is detected.

Based on this configuration, the one embodiment of the present invention can use a character having a given condition such as a character that clears a task in a game or clears a task of staying in a virtual space of a metaverse for a given period, and therefore, the user's interest in the character can be improved.

The “given condition” includes a condition such as a task in the game being cleared, a condition based on a charge history being achieved, or a condition in a metaverse being cleared for a predetermined staying time.

(10) In an embodiment of the present invention, the character management system has
a user status detection unit to detect a charging history of the user or a game situation of the game played by the user, as the user status,
wherein the modified character creation process unit determines a configurable composing element based on the detected user status, and creates the modified character based on a determined composing element.

Based on this configuration, the one embodiment of the present invention can set the modified character accordance with the charge amount of the user or the depth of the game, the motivation of the user for the charge or the motivation of the user for playing the game can be improved.

The “charging history” includes, for example, the date and time when the user has charged, the amount charged, and the content of the charging (charged items).

The “game situation” includes the number of sound sources, the number or positions of the player character or the enemy character, the terrain or the local environment where the player character is located, the game score of the individual or the team, the game stage that the player character has cleared or is challenging, the type of equipment such as a weapon possessed by the player character, the level of the player character or the enemy character, the ability possessed by the player character or the enemy character or the level of the ability, the task clearing situation, and the situation of the game event.

(11) In an embodiment of the present invention, the character management system has
the composing element that includes at least one of an item equipped to the character, a parameter set to the character, and a sound related to the character.

Based on this configuration, the one embodiment of the present invention can change items and abilities used by the character, the voice of the character, sound effects at the time of appearance of the character, and the like, and therefore, the user's attachment to the character can be improved.

The “equipped items” include, for example: tools such as weapon, protective gears, magic, agricultural tool, industrial tool, and daily commodities used by the characters; vehicles such as weapons or means of transportation; decorative elements such as costumes; accessories, and cosmetics; other accompanying characters such as pets and robots; and provided gifts.

The “parameters” include, for example: various ability parameters used in the game or the like, life or energy parameters, parameters relating to a privilege in the virtual space, such as the number of challenges to a lottery, and the amount of points or the amount of money in the virtual space held by the user who owns the character.

The “sound related to the character” includes, for example, a song or sound effect when the character appears in an event, and an action sound when the character attacks in the game, in addition to the voice created by the character.

(12) In an embodiment of the present invention, the character management system has
a providing unit to provide the information of a determined composing element to another user as composing element information for another user modified character,
wherein the modified character creation process unit creates, as the modified character creation process, the modified character by modifying the composing element of the base character based on the composing element information for another user modified character.

Based on this configuration, the one embodiment of the present invention can create the modified character by using the composing elements of the other player based on the base character of the player himself/herself, the taste of the preference of the other player can be taken into the base character of the player himself/herself.

Accordingly, the embodiment of the present invention can create various characters such as characters beyond the imagination of each user, and therefore, the interest in the creation of characters can be improved.

(13) In an embodiment of the present invention, the character management system has
a modification strength setting unit to set a modification strength of the composing element based on a given instruction,
wherein the modified character creation process unit creates the modified character in which the composing element is modified from the base character based on the set modification strength.

Based on this configuration, the one embodiment of the present invention can change the setting of the modified character by different modification strengths even when the same composing elements are modified for the same base character.

Accordingly, in the embodiment of the present invention, since the alteration strength can be changed by the user himself or by the system administrator, various modified characters can be created.

(14) In an embodiment of the present invention, a character management method for managing a character used in a virtual space, having: managing, as base character information, information of a base character whose composing elements are changeable and which is stored in a storage unit for managing a character;
acquiring user related information regarding a user or user input information including at least one of text information, image information, and voice information that are input by the user, the user related information having been already stored in a storage unit for user management;
determining, based on an acquired user related information or an acquired user input information, the content of the composing element of the base character, a composing element to be changed from among the composing elements of the base character, or a composing element to be added to the base character;
executing a modified character creation process of creating a modified character in which the composing element is modified from the base character based on the content of the determined composing element, the composing element to be modified, or the composing elements to be added.

Based on this configuration, the present invention can create the modified character in which the composing elements of the base character are changed based on the information of a user assumed to reflect the preference of the user such as a player or the information inputted by the user himself/herself, and can create the modified character only by the information already stored or the inputted information.

Accordingly, the one embodiment of the present invention can create the player character that accurately reflects the preference of the player while eliminating the complexity of creating the player character.

(15) In an embodiment of the present invention, a character management method for managing a character used in a virtual space, having:
managing, as base character information, information of a base character whose composing elements are changeable, and which is stored in a storage unit for managing a character;
acquiring user related information regarding a user, the user related information having been already stored in a storage unit for user management;
executing a modified character creation process of creating a plurality of modified characters in which the composing element is modified from the base character based on an acquired user related information; and
presenting to the player information of a created modified character as modified character information, Based on this configuration, the present invention can create the modified character in which the composing elements of the base character are changed based on the information of a user assumed to reflect the preference of the user such as a player or the information inputted by the user himself/herself, and can create the modified character only by the information already stored or the inputted information.

Accordingly, the one embodiment of the present invention can create the player character that accurately reflects the preference of the player while eliminating the complexity of creating the player character.

(16) In an embodiment of the present invention, a character information providing method for providing information of a character to a terminal device from a server that executes a modified character registration creation process including a modified character registration creation process for a modified character indicating a modified character used in a virtual space, having
the server having:
   a management unit to manage, as base character information, information of a base character whose composing elements are changeable, and which is stored in a storage unit for managing a character;
   an acquisition unit to acquire user related information regarding a user or user input information including at least one of text information, image information, and voice information that are input by the user, the user related information having been already stored in a storage unit for user management;
   a composing element determination unit to determine, based on an acquired user related information or an acquired user input information, the content of the composing element of the base character, a composing element to be changed from among the composing elements of the base character, or a composing element to be added to the base character;
   a modified character creation unit to execute a modified character creation process of creating a modified character in which the composing element is modified from the base character based on the content of the determined composing element, the composing element to be modified, or the composing elements to be added,
wherein information of the operation of the user received by the terminal device is transmitted to the server device; and
   the character information is received from the server.

Based on this configuration, the present invention can create the modified character in which the composing elements of the base character are changed based on the information of a user assumed to reflect the preference of the user such as a player or the information inputted by the user himself/herself, and can create the modified character only by the information already stored or the inputted information.

Accordingly, the one embodiment of the present invention can create the player character that accurately reflects the preference of the player while eliminating the complexity of creating the player character.

(17) In an embodiment of the present invention, a character information providing method for providing information of a character to a terminal device from a server that executes a modified character registration creation process including a modified character registration creation process for a modified character indicating a modified character used in a virtual space, having
the server having:
   a management unit to manage, as base character information, information of a base character whose composing elements are changeable, and which is stored in a storage unit for managing a character; an acquisition unit to acquire user related information regarding a user, the user related
   information having been already stored in a storage unit for user management;
   a modified character creation unit to execute a modified character creation process of creating a plurality of modified characters in which the composing element is modified from the base character based on an acquired user related information; and
   a presentation unit to present to the player information of a created modified character as modified character information,
wherein information of the operation of the user received by the terminal
device is transmitted to the server device; and
the character information is received from the server.

Based on this configuration, the present invention can create the modified character in which the composing elements of the base character are changed based on the information of a user assumed to reflect the preference of the user such as a player or the information inputted by the user himself/herself, and can create the modified character only by the information already stored or the inputted information.

Accordingly, the one embodiment of the present invention can create the player character that accurately reflects the preference of the player while eliminating the complexity of creating the player character.

Hereinafter, preferred embodiments of the present invention will be described. Note that the following embodiments do not unduly limit the scope of the invention as stated in the claims. In addition, all of the elements described in connection with the following embodiments should not necessarily be taken as essential requirements of the invention.

In the following embodiments, a player character used by a player in a game space is basically used as a character used by a user in a virtual space. Note that this does not apply to the case where characters used for other than games are mentioned.

### [1] Game System

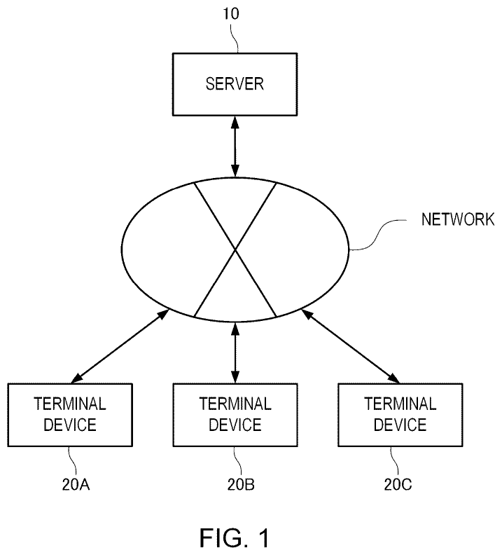

First, the outline and configuration of a game system S in the present embodiment will be described with reference FIG. 1. FIG. 1 is an example of the system configuration diagram illustrating a configuration of the game system S according to the present embodiment.

As illustrated in FIG. 1, the game system S according to is configured such that: a sever 10 which provides a game service; and a terminal device 20 (e.g., terminal devices 20A, 20B, and 20C) can be connected to the Internet (an example of a network).

The user can play the game transmitted from the server 10 via the Internet by accessing the server 10 from the terminal device 20. The user can communicate with other users by accessing the server 10 from the terminal device 20.

The game server 10 is an information processing device capable of providing a service for allowing the user to play the game by using the terminal device 20 communicatively connected to the server 10 via the Internet. The server 10 may also function as an SNS server that provides communication-type services. The SNS server may be an information processing device that provides a service capable of providing communication among a plurality of users.

The server 10, for example, when functioning as the SNS server, can provide a game called a social game executed by an operating environment (API (Application Programming Interface), a platform, etc.) of the provided SNS.

Specifically, the server 10 can provide the browse game (a game that is started only by opening an Web site with a Web browser) written in various languages such as HTML, FLASH (registered trade mark), CGI, PHP, shockwave, Java (registered trade mark) applet, and JavaScript (registered trade mark).

The social games include games that do not require specialized client software and can be used only with the Web browser and a SNS account, unlike existing online games. The server 10 is connected to the terminal device (a smartphone, a personal computer, a game device, etc.) 20 of another user via the network, and has a configuration capable of sharing the progress of the game online.

On the other hand, the server 10 may be configured by one device (or processor) or a plurality of devices (or processors).

Information such as charging information and game play information stored in a storage area (a storage unit 140 to be described later) of the server 10 may be stored in a database (a storage device or a memory in the broad definition) connected via the network (an Intranet or the Internet), or information of the player information storage unit 146 stored in the storage area may be stored in a database (a storage device or a memory in a broad definition) connected via a network (an intranet or the Internet) when the game server functions as an SNS server.

Specifically, the server 10 according to the present embodiment receives input information based on an operation of the user of the terminal device 20 (i.e., a player executing a game), and performs a game process based on the received input information. The server 10 transmits the game processing result to the terminal device 20, and the terminal device 20 performs various processes of providing the game processing result received from the server 10 so that the user (i.e., player) can view the game processing result.

The terminal device 20 is an information processing device such as a smartphone, a cellular phone, a computer, a game device, a PDA, a tablet, a portable game device, an image generating device, or the like, and is a device connectable to the server 10 via the network. Note that the communication line between the terminal device 20 and the game server 10 may be a wired or wireless.

The terminal device 20 has a function of the Web browser capable of browsing Web pages (data in HTML format). That is, the terminal device 20 performs a communication control function for communicating with the server 10, and performs display control by using data (Web data, data created in the HTML format, or the like) received from the server 10. The terminal device 20 has a Web browser function for transmitting data of user's operations to the server 10, and executes to play the game by the user by executing various processes for providing the user with a game screen. Note that the terminal device 20 may acquire the game control information provided from the server 10, execute the game process, and execute a game based on the game process.

Specifically, when requesting the server 10 to play a predetermined game, the terminal device 20 is connected to the game site of the server 10 and the game is started. By using on an API as necessary, the terminal device 20 has a configuration to control the server 10 functioning as an SNS server that executes a predetermined process, or to acquire the player information managed the server 10, in order to execute a game.

### [2] Server

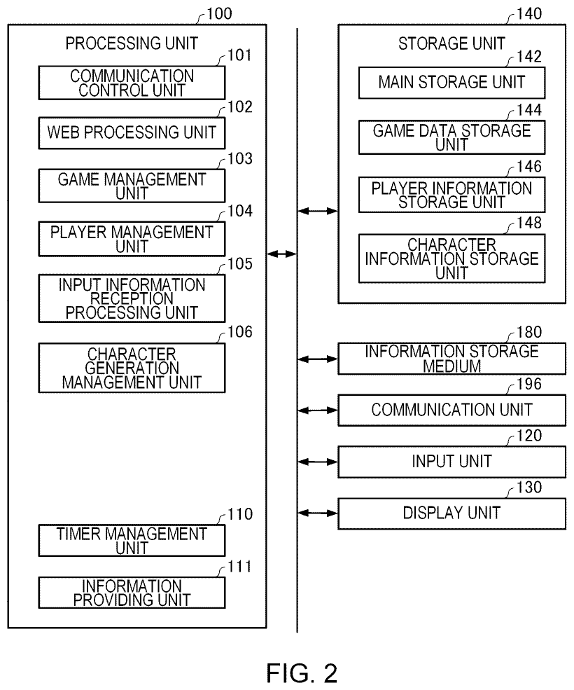

Next, the configuration according to the server 10 of the present embodiment will be described with reference to FIG. 2. FIG. 2 is an example of a functional block diagram illustrating the server 10 according to the present invention. The server 10 of the present embodiment may be configured by omitting one or more composing elements shown in FIG. 2.

The game server 10 includes: an input unit 120 used for input by a system administrator and others; a display unit 130 for performing a predetermined display; an information storage medium 180 in which predetermined information is stored; a communication unit 196 for communicating with a terminal device 20 and others; a process unit 100 for executing processes relating to the game to be mainly provided; and a storage unit 140 for storing various data mainly used for the game.

The input unit 120 is used by the system administrator or the like to input settings related to the game, other necessary settings, and data. For example, the input unit 120 of the present embodiment is configured by a mouse, a keyboard, or the like.

The display unit 130 displays an operation screen for the system administrator. For example, the display 130 of the present embodiment serves as a display of the present invention.

In the information storage medium 180 (a computer-readable medium), programs, data, and the like, are stored. The functions of the information storage medium 180 are configured by hardware such as an optical disc (CD or DVD), magnetic optical disc (MO), magnetic disc, hard disc, magnetic tape, or memory (ROM).

The communication unit 196 performs various controls to communicate with an external device (for example, a terminal device, another server, another network system). The functions of the communication unit 196 can be configured by hardware of various processors or ASICs for communication, program and so on.

The storage unit 140 serves as a work area for the process unit 100, the communication unit 196, and the like, and its functions are configured by a RAM (VRAM) or the like. The information stored in the storage unit 140 may be managed by a database. The information stored in the storage unit 140 may be managed by a database.

The storage unit 140 of the present embodiment has the main storage unit 142, in addition to:
(A1) a game data storage unit 144 in which game information indicates that relates to the game;
(A2) a player information storage unit 146 in which the player-related information indicates the information relating each of the player (hereinafter referred to as “player-related information”); and
(A3) a character information storage unit 148 in which information of the base character (hereinafter referred to as “base character information”) of each player, information of a modified character (hereinafter referred to as “modified character information”) indicating information of a character modified from the base character, and information (hereinafter referred to as “constituent element information”) of a composing element configuring the character.

In the game data storage unit 144, information of a game field in which a game is played, condition information used for various determinations, information of each object on the game field, information for changing each object, various table information, information of the player character of each player, information of each item used in the game, and the like.

The processor 100 executes various processes using the main storage unit 142 in the storage unit 140 as a work area. The processor 100 is implemented by hardware such as various processors (CPU, DSP, etc.), ASICs (gate arrays, etc.), and programs.

The processor 100 is configured to perform the various processes of the present embodiment based on programs (data) stored in the information storage medium 180. In the information storage medium 180, a program for causing a computer to function as each unit of the present embodiment (a program for causing the computer to execute the process of each unit) can be stored.

For example, the process unit 100 (processor) controls the entire server 10 based on the program stored in the information storage medium 180, and executes various processes such as control of transfer of data and the like between the units. The process unit 100 executes processes for providing various services in response to requests from the terminal device 20.

The process unit 100 of the present embodiment includes at least a communication control unit 101, a Web process unit 102, a game management unit 103, a player management unit 104, an input information reception process unit 105, a character creation management unit 106, a timer management unit 110, and an information providing unit 111.

The communication control unit 101 processes data transmission and reception via a network with the terminal device 20. That is, the server 10 executes various processes based on the information received from the terminal device 20.

The communication control unit 101 of the present embodiment executes a process for transmitting a game screen to the terminal device 20 of the player based on a request from the terminal device 20 of the player.

The communication control unit 101 executes various processes for accepting instructions of the player input to the terminal device 20.

The Web process unit 102 functions as a Web server. For example, the Web process unit 102 executes the process for transmitting data in response to a request from the Web browser 211 installed in the terminal device 20 and the process for receiving data transmitted by the Web browser 211 of the terminal device 20 through a communication protocol such as HTTP (Hypertext Transfer Protocol).

Note that the server 10 is described as having a function as an SNS server in the present embodiment. The server 10 may be formed separately from the game server and the SNS server. The server 10 may executes a part or all of the process of the game of the present embodiment, or the terminal device 20 may execute a part of the process of the game of the present embodiment.

The game management unit 103, in conjunction with the terminal device 20, and builds the game space as a virtual space, and executes various game processes relating to various 1 multiplayer games such as a battle game in which a plurality of players fight or battle each other, an action game, an RPG, a sound game, or a sports game based on the operation of the players inputted through the terminal device 20.

The game management unit 103 executes various processes based on instructions of the player transmitted from the terminal device 20.

The game management unit 103 controls movement in the game space and each action for the game in the player character to be operated by each player in accordance with the operation input of the player input to the terminal device 20. The game management unit 103 executes the actions of other related characters and objects and various game processes.

The game management unit 103 instructs and manages the execution of a modified character creation and registration process for modifying the player character defined as a base character for each player, creating a new player character (hereinafter referred to as an “modified character”), and registering the new player character.

The game management unit 103 manages the base character and the modified character for each player, and manages the use of these characters in the virtual space of the game, the metaverse and the like.

The game management unit 103 may execute various game processes for a single player character or a plurality of player characters based on an instruction from one player.

The player management unit 104 registers and manages items owned by the player and acquired privileges as player information in the player information storage unit 146, and manages a player character set by the player during the game or a deck in which the player character is set.

The player management unit 104 manages the player and manages information (hereinafter referred to as “player-related information”) regarding the player character that was used by the player in the past.

When the modified character creation registration process is executed, the input information reception process unit 105 acquires the player-related information stored in the player information storage unit 146 or the player's input information inputted by the player from the terminal device 20.

When the modified character creation and registration process is executed, the character creation management unit 106 executes the modified character creation and registration process for managing the base character stored in the character information storage unit 148 for each player, and for creating a modified character by modifying the composing elements from the base character.

The character creation management unit 106 registers the information of the created modified character as modified character information in the character information storage unit 148.

The timer management unit 110 has a timer function and is used to manage the progress status of the game. In particular, the time management unit 110, in cooperation with the game management unit 103, outputs the current time and a preset time to each unit. The timer management unit 110 is used for synchronization with each terminal device 20.

The information providing unit 111 generates various game information for the terminal device 20 to process the game and provides the generated information to the terminal device 20.

The information providing unit 111 provides the registered modified character information to the corresponding terminal device 20 based on the instruction of the player.

### [3] Terminal Device

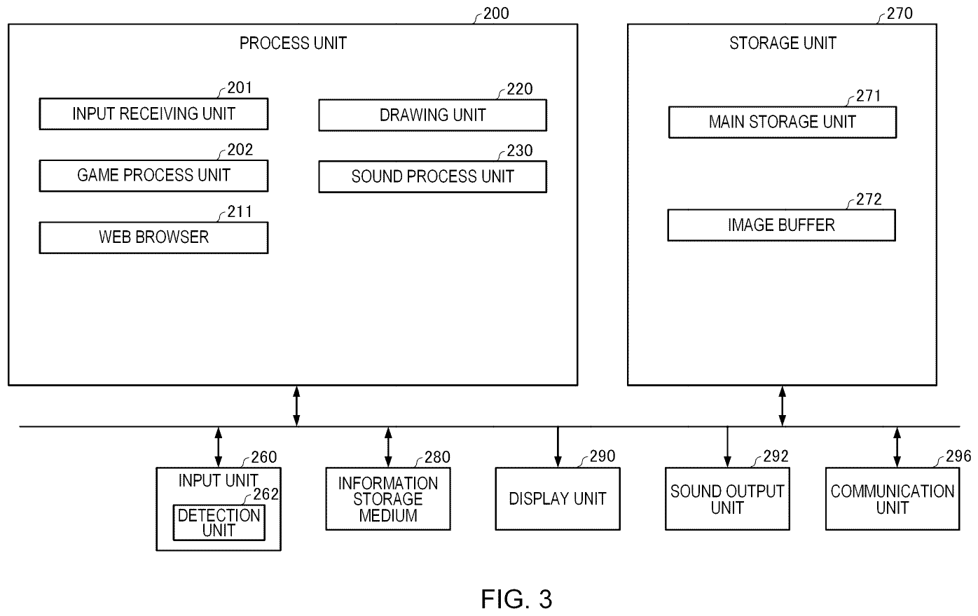

Next, the configuration of the terminal device 20 of the present embodiment will be described with reference to FIG. 3. FIG. 3 is an example of a functional block diagram illustrating the terminal device 20 according to one embodiment of the present invention. The terminal device 20 of the present embodiment may be configured by omitting one or more composing elements shown in FIG. 3.

The operation unit 260 is used for entering operation data by the player, and is configured by a touch panel or a touch panel type display. Specifically, the operation unit 260 has a detection unit 262 that is capable of detecting two-dimensional instruction position coordinates (x, y) on a screen on which images are displayed. For example, the operation unit 260 includes a detection unit 262 capable of detecting two-dimensional contact position coordinates (x, y) in a contact detection area (touch panel).

The operation of contacting the display screen (hereinafter referred to as “touch panel” except in special cases) 12 may be performed by using a fingertip or an input device such as a touch pen.

Further, the operation unit 260 may have buttons, levers, a keyboard, a steering wheel, a microphone, an acceleration sensor, and the like that can input operation information (operation signals) other than the indicated position.

The storage unit 270 serves as a work area for the process unit 200, the communication unit 296, and the like, and its functions are configured by a RAM (VRAM) or the like. The storage unit 270 of the present embodiment includes a main storage unit 271 used as a work area and an image buffer 272 in which a final display image and the like are stored. The storage unit 270 may omit a part of these components, or the storage unit 140 of the server 10 may have a part of the components.

The information storage medium 280 (a computer-readable medium), stores programs, data, and the like. The functions of the information storage medium 280 are implemented by hardware such as an optical disc (CD or DVD), magnetic optical disc (MO), magnetic disc, hard disc, magnetic tape, or memory (ROM).

In the information storage medium 280, a program for causing a computer to function as each unit of the present embodiment (a program for causing the computer to execute the process of each unit) can be stored. The processor 200 is configured to execute the various processes of the present embodiment based on programs (data) stored in the information storage medium 280.

A display unit 290 displays a given image generated by the present embodiment. The function of the display unit 190 can be implemented by a CRT, an LCD, a touch panel type display, or an HMD (head mounted display) and so on.

In the present embodiment, the display unit 290 also functions as the operation unit 260 used by the player that performs a game operation with a touch panel display. As the touch panel, for example, a touch panel of a resistive film type (four wire type, five wire type), a capacitance type, an electromagnetic induction type, an ultrasonic surface acoustic wave type, an infrared scanning type, or the like can be used.

A sound output unit 292 outputs a sound that is generated by the present embodiment. The function of the sound output unit 192 can be implemented by a speaker, a headphone and the like.

The communication unit 296 executes the various controls to communicate with an external device (for example, a host computer and another terminal device). The functions of the communication unit 196 can be configured by hardware of various processors or ASICs for communication, program and so on.

The programs and the data for making the computer function as the units of the present embodiment that are stored in the information storage medium 280 or the storage unit 270 of the server 10 may be received via the network, and be stored in the information storage medium 280 or the storage unit 270. The case in which the terminal is made to function by receiving the program or data in this manner is also included within the scope of the present invention.

The processor 200 executes a game process, an image generation process, a sound generation process, and so on, based on input data and programs from the operation unit 260.

Specifically, the game processes include a process of starting a game when a game start condition is satisfied, a process of advancing a game, a process of arranging objects such as a player object and an enemy object, a process of displaying the objects, a process of calculating a game result, a process of ending a game when a game end condition is satisfied, and the like.

The processor 200 executes various processes using the storage unit 27 as a work area The processor 200 is implemented by hardware such as various processors (CPU, DSP, etc.), ASICs (gate arrays, etc.), and programs.

The process unit 200 of the present embodiment includes an input receiving unit 201, a game process unit 202, a Web browser 211, a drawing unit 220, and a sound process unit 230. Note that one or more of these units may be omitted from the configuration.

The input receiving unit 201 receives the input instruction of the player input by the operation unit 260, and provides the received input instruction to the server 10 under the control of the game process unit 202.

The game process unit 202 provides the command received by the input receiving unit 201 to the server 10.

The game process unit 202 receives the game control information or the modified character information provided from the server 10, and controls the input receiving unit 201, the drawing unit 220, and the sound process unit 230 based on the received game control information and the received modified character information.

The game process unit 202 sets the player characters and various items to be used in the game such as the multiplayer game in each player based on the operation of the player input via the operation unit 260, and provides the set player characters and various items to the server 10.

The web browser 211 is an application program for browsing web pages (a game screen and a live game streaming play screen), and downloads HTML files, image files, and the like from a web server (server 10), analyzes layouts, and controls display. The web browser 211 transmits data to the web server (server 10) using an input form (link, button, text box, or the like).

The Web browser 211 of the present embodiment can execute a browser game or viewing of the live game streaming. For example, the Web browser 211 may execute a program written in JavaScript (registered trademark), FLASH, Java (registered trademark), or the like received from a Web server.

The terminal device 20 can display information from a Web server designated by a URL via the Internet by the Web browser 211. For example, the terminal device 20 can display the game screen (data such as HTML) received from the server 10 by the Web browser 211.

The drawing unit 220 executes a drawing process based on the results of various processes executed by the processor 100, generates images by drawing process, and outputs the image to the display unit 290.

The sound controller 230 executes the sound process based on the results of various processes performed by the processor 200, generates a game sound, such as a BGM, an effect sound, or a voice, and outputs the image to the display section 292.

### [4] Method of the Present Embodiment (Modified Character Creation and Registration Process)

### [4-1] Outline

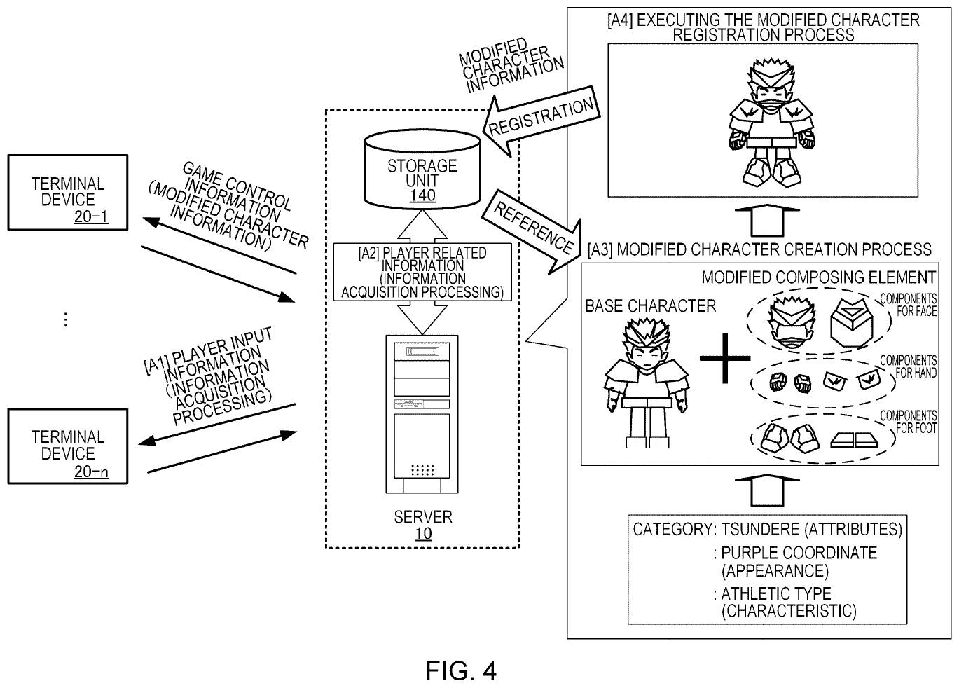

Next, the modified character creation and registration process executed by the server 10 of the present embodiment will be described with reference to FIG. 4.

FIG. 4 is a diagram for explaining the modified character creation and registration process executed by the server 10 of the present embodiment.

The server 10 of the present embodiment has a configuration for executing a given game such as an RPG, a battle game, a shooting game, a simulation game, a multiplayer game, battle game, and a town planning game for a plurality of players in the same game space.

That is, the server 10 of the present embodiment has a configuration for executing a given game in a game space in which a plurality of player characters operated by the plurality of players can act.

The server device 10 of the present embodiment has a configuration for controlling sound effects of a game when a given game event occurs in a game space such as an event of fighting an enemy character, an event of searching a predetermined area, an event of appearance (birth) of an enemy character or the like, an event of victory or defeat in a battle, an event of accomplishing a task, an event of collision between a character and an arranged object such as a wall, an event of weather change, or an event of executing a mini game.

The server 10 of the present embodiment has a configuration to create the modified character, which is the modified base character by changing a composing element such as the appearance, decoration, or equipment of the base character, and to register the created modified character in order to use the modified character in a game or the like.

In other words, the server 10 of the present embodiment has a configuration capable of eliminating the complexity of creating a character by creating the modified character using the base character, and of creating the character that can be used in a game or the like and accurately reflects the preference of the user.

Specifically, the server 10 of the present embodiment has a configuration in which information of a base character whose constituent elements are defined is managed as base character information.

As shown in FIG. 4, the server 10 is a configuration to execute:
(A1) an information acquisition process for acquiring player-related information regarding a player that has already been stored or player's input information including at least one of text information, image information, and voice information input by the player;
(A2) a composing element determination process for determining the contents of the composing elements of the base character, a composing element to be changed among the composing elements of the base character, or a composing element to be added to the base character, based on the acquired user-related information or user input information;
(A3) a modified character creation process for creating a modified character by modifying the composing elements from the base character based on the content of the determined composing element, the composing element to be modified, or the composing element to be added; and
(A4) a modified character registration process for registering the created information of the modified character as modified character information.

FIG. 4 shows that:
(B1) a category (taste) such as an attribute, an appearance, or a characteristic is set by player's input information or player-related information;
(B2) the modified character is created by a player's instruction or at random or the like while referring to the base character and various composing elements stored in the storage unit 140 based on the set category; and
(B3) the modified character is registered in the storage unit 140.

Specifically, FIG. 4 shows that: in the modified character creation process, two selectable components for each of the face, hand, and foot are read out according to the category; and the modified character is created by incorporating the composing elements specified by the player's instruction or the like among the read composing elements into the base character.

Based on such a configuration, the server 10 of the present embodiment can create the player character that accurately reflects the preference of the player while eliminating the complexity of creating the player character.

### [4-2] Various Information

### [4-2-1] Player-Related Information

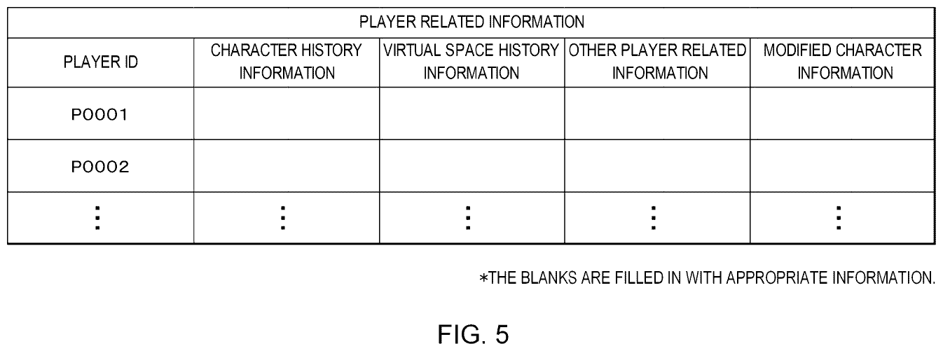

Next, the player-related information stored in the player information storage unit 146 in the present embodiment will be described with reference to FIG. 5.

FIG. 5 is a diagram illustrating an example of the player-related information stored in a player information storage unit 146 according to the present embodiment.

### Overview of Player-Related Information

The player-related information includes, for each player, information associated with a player ID as shown in FIG. 5:
(A1) history information (hereinafter referred to as “character history information”) of characters which had a relationship with each user in the past, and which includes the player character;
(A2) history information (hereinafter referred to as “virtual space history information”) of the virtual space (game space) in which each player character has existed;
(A3) player-related information (hereinafter referred to as “other player-related information”) of other players related to each player registered as a friend, including the player character; and
(A4) information (modified character information) of the modified character created by the modified character creation process.

Further, the information related to each character included in (A1) to (A3) includes image information relating to the composing element of the character or virtual space such as color, decoration, or sound.

The modified character information is information defining a modified character created for each player and each time the character modification process is executed, and is managed for each player.

The player-related information includes, in addition to the above information:
(B1) the player's nickname and, if the player belongs to a team, the name of the team and the ID thereof (hereinafter referred to as “belonging information”);
(B2) information (hereinafter also referred to as “performance information”) on the performance of the player and the team, such as the player's current score, experience value, energy parameter (life energy value, physical strength value, or power value), and the acquired reward or game time;
(B3) information on charging such as charging history and charging amount;
(B4) information (hereinafter referred to as “access history information”) on a log-in (access) history;
(B5) information on the acquired privilege (hereinafter also referred to as “acquired privilege information”); and
(B6) information (hereinafter referred to as “related player information”) of another player (hereinafter also referred to as “related player”) having a certain relationship such as a friend or a follower.

### Character History Information

The character history information is history information of:
(C1) the player character used by the player in the virtual space (that is, a game space);
(C2) the character (hereinafter referred to as a “contact character”) that has been in contact with the player character, such as a character that has been talking with the player character as a conversation partner in the virtual space, a character that has played a game with the player character, or a cooperative character that has cooperated with the player character to perform a given task;
(C3) a character (hereinafter referred to as a “gaze character”) that is a viewing target of a performance such as an acting or a singing in the virtual space;
(C4) a character (hereinafter referred to as a “relationship player character”) of another player having a given relationship such as another user who has been registered; and
(C5) a character (hereinafter referred to as a “same tendency other player character”) assumed to have the same tendency as the player, such as a character of another user who has accessed the same virtual space in the same time period as the player.

The character history information includes information on composing elements composing the appearance of the character or the like, or information on characteristics (color, shape, or sound) of the composing elements.

Specifically, the character history information includes various information of the color, shape, or sound of the modified character associated with an ID (character ID) of a character when the modified character is created, such as:
(D1) a character type such as (C1) to (C5);
(D2) attributes of a character such as a human, a robot, or an animal;
(D3) information (hereinafter referred to as “appearance information”) of the entire character (clothes and figure), the color, shape, and decoration of each component (hair style, eyes, mouth, nose, hands and feet, hat and glasses) composing the character, or a combination thereof;
(D4) Information (hereinafter referred to as “item information”) of items (weapons and tools) possessed by the character, including color and shape;
(D5) Information (hereinafter referred to as “character sound information”) about the voice of the character, sound effect, or sound such as music at the time of appearance of the character; and
(D6) time-related information such as the registration date and time and the usage period of the player character, the date and time and the period of contact of the contact character, and the date and time and the period of a gaze of a gazed character, and the like.

In the character history information, the appearance information and the item information may be formed by text information or image information.

The character history information of the contact character, the gazing character, the related player character, and the same tendency other player character may be formed by at least the character ID and the time-related information, and may be provided by referring to the character information in which each character is originally stored, such as the game data storage unit 144 or the other player-related information.

### Virtual Space History Information

The virtual space history information includes, for example, information of a composing element of the virtual space or information of a characteristic (color, shape, or sound) of the composing element, the composing element of the virtual space including a spatial composing element (color, decoration, or sound) of the virtual space in which the characters existed in the past, the characters being the user character or the character that had a given relationship with the user in the past.

For example, the virtual space history information includes:
(E1) an ID (hereinafter referred to as “space ID”) of the virtual space in which each player character has existed;
(E2) the date and time or period when each player character has existed in the virtual space; and
(E3) color information for forming the virtual space and decoration information, and sound information that includes sound effects.

As with the character history information, the virtual space history information may include at least only the space ID, and may be referred to the virtual space information stored in the game data storage unit 144.

### Overview of the Other Player-Related Information

For example, the other player-related information may include:
(F1) information (hereinafter referred to as “relationship information”) indicating a relationship with the player;
(F2) information of the date and time when the relationship was established or the period during which the relationship is maintained; and
(F3) character history information of the player character possessed by another player.

Specifically, the character history information of the other player may be the above-described character history information of the player, such as the player ID and the character ID of the other player, or information for referring to the character information of the other player.

### Modified Character Information

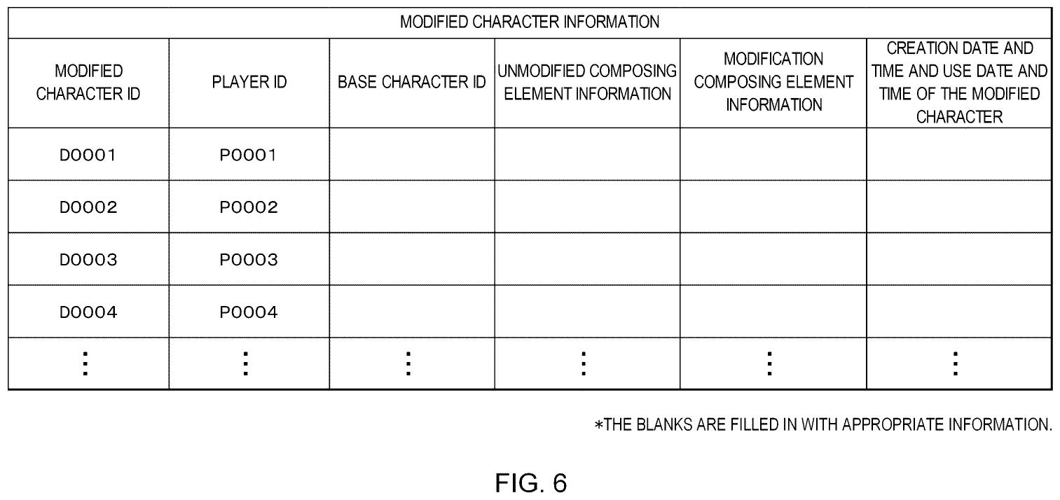

For example, as shown in FIG. 6, the modified character information has, associated with a modified character ID identifiable for each player:
(G1) a base character ID of a modification source;
(G2) information (hereinafter referred to as “unmodified composing element information”) of the unmodified composing element;
(G3) information (hereinafter referred to as “modified composing element information”) of the modified composing element such as a part of the modified composing element and the composing element ID for specifying the composing element; and
(G4) creation and use history information such as creation date and time and use date and time of the modified character.

### [4-2-2] Base Character Information and Composing Element Information

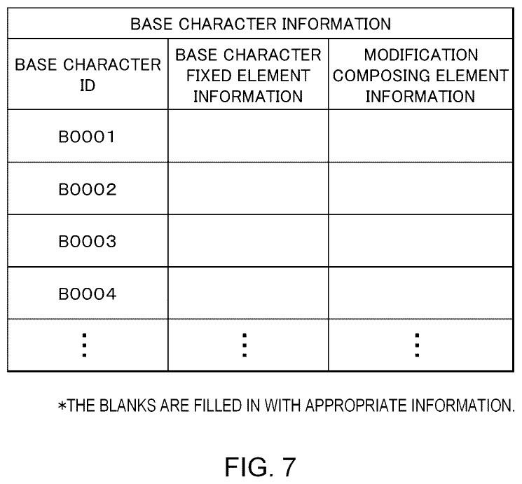

Next, the base character information stored in the character information storage unit 148 in the present embodiment will be described with reference to FIG. 7.

FIG. 7 is a diagram illustrating an example of the base character information stored in the player information storage unit 146 according to the present embodiment.

### Base Character Information

The base character information includes information of the composing elements for forming the character, and is information on the character that is set in advance by the player or the system administrator and that is a base for creating a modified character.

For example, a component includes:
(A1) the appearance of the character (hair style, eyes, mouth, nose, hands and feet, body, skin color, etc.);

(A2) the equipment (such as weapons) or the accessories (such as glasses, hats, or accessories) worn by the character;
(A3) sound such as the voice and the sound effect;
(A4) items to be equipped on the character; and
(A5) parameters set for the character.

The parameters include, for example: various ability parameters used in the game or the like, life or energy parameters, parameters relating to a privilege in the virtual space, such as the number of challenges to a lottery, and the amount of points or the amount of money in the virtual space held by the user who owns the character.

The sound related to the character includes, for example, a song or sound effect when the character appears in an event, and an action sound when the character attacks in the game, in addition to the voice created by the character.

As shown in FIG. 7, the base character information includes, for each base character ID for identifying the base character:
(B1) the fixed information (hereinafter referred to as “base character fixed element information”) that is the player character serving as the base character and the item, and that is not a target not to be modified; and
(B2) information (hereinafter referred to as “modified composing element information”) of a composing element which is an element of (A1) to (A5) forming the base character and is a target to be modified.

The items include, for example, tools such as weapon, protective gears, magic, agricultural tool, industrial tool, and daily commodities used by the characters, vehicles such as weapons or means of transportation, decorative articles such as costumes, accessories, and cosmetics, other accompanying characters such as pets and robots, and provided gifts.

The base character fixed element information includes elements such as a body shape or a skeleton, a color or decoration as a base, and various levels or abilities, and varies for each player character or item.

### Modification Selection Composing Element Information

The modification selection component information is information of each composing element incorporated in the base character when the character modification process is executed.

Specifically, the modification selection composing element information has a type of a composing element and image information or sound information in association with the element ID for identifying the composing element for each composing element.

Each of the modification selection composing element information has information (hereinafter referred to as “category information”) of one or more categories such as “a tsundere type (a type of playing hard to get)”, “an easygoing type (saba-saba in Japanese)”, or “an athletic type.”

Specifically, the category information may be information classified into a plurality of hierarchies such as a large classification, a medium classification, and a small classification, and a plurality of category information may be defined in each of the modification selection composing element information.

Each of the modification selection composing element information includes the employment history of each player, the strength (hereinafter referred to as “alteration strength”) of the element of the corresponding category such as “high degree of the tsundere” or “low degree of the easygoing type”, and the like, and includes special remarks such as strong redness or high affinity with other composing elements.

### [4-3] Information Acquisition Processing

Next, the information acquisition process executed by the server 10 of the present embodiment will be described.

When the modified character creation registration process is executed, the input information reception process unit 105 acquires the player-related information stored in the player information storage unit 146 or the player's input information inputted by the player from the terminal device 20.

The input information reception process unit 105 acquires, as the player-related information or the player's input information, information on the appearance of the modified character desired by the player, or information on the property, character, characteristic, or attribute (text information, image information, or voice information).

Specifically, the input information reception process unit 105 acquires the character history information, the virtual space history information, and the other player-related information as the player-related information stored in the player information storage unit 146.

The input information reception process unit 105 acquires, from the terminal device 20, the text information input by the player using an input device such as a keyboard, a tablet, or a voice as player's input information.

The input information acceptance process unit 105 may acquire image information and voice information from the terminal device 20 as player's input information, instead of the text information.

In the present embodiment, the input information reception process unit 105 may detect and acquire the charging history of the player or the game situation of the game played by the player as the player-related information, instead of or in addition to the above.

That is, the input information reception process unit 105 detects the charging history of the player or the game situation of the game played by the player as the player situation.

### [4-4] Composing Element Determination Process

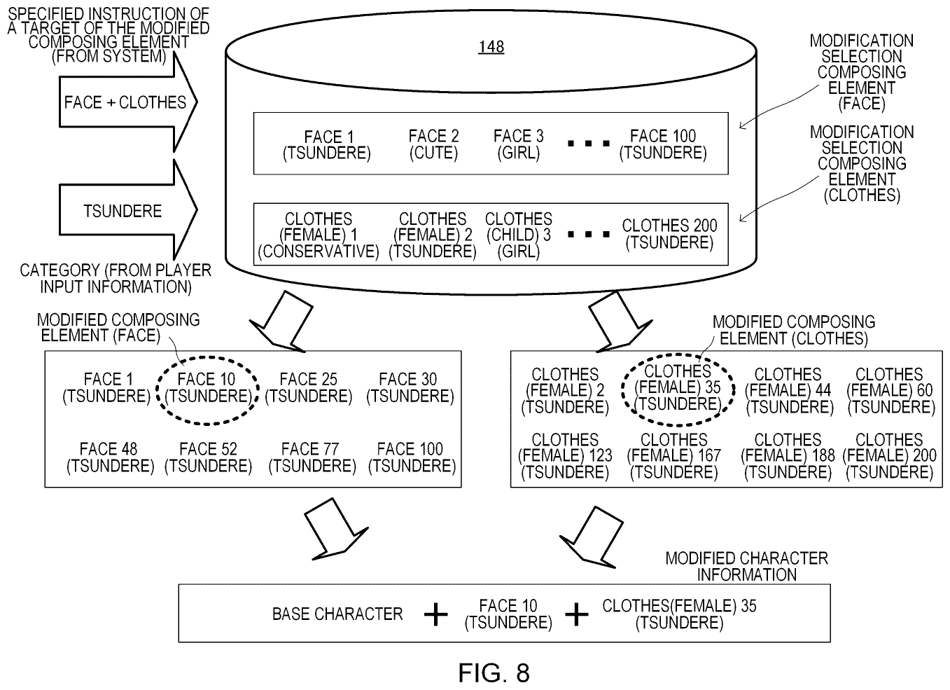

Next, the composing element determination process executed by the server 10 of the present embodiment will be described with reference to FIG. 8.

FIG. 8 is a diagram for explaining a character modification process executed by the server 10 of the present embodiment.

### Determination of Categories

The character creation management unit 106 executes the composing element determination process of determining the composing element to be changed among the composing elements of the base character based on the acquired user related information or player's input information.

In order to determine the composing element to be changed among the composing elements of the base character, the character creation management unit 106 acquires the directionality of the modification of the base character for the player, such as the player's preference (taste), as a category from the user related information or the player's input information.

The character creation management unit 106 acquires, as categories, from the user related information or the player's input information, characteristics such as an atmosphere of a tsundere or a cute, a personality of gentle or hot-tempered, a rich, an athletic type, or color characteristics including a blue base, a primary color base, a pop image and a dark image.

Specifically, when the player's input information matches the category defined in the modification selection composing element information, the character creation management unit 106 acquires the player's input information as it is as the category.

For example, when acquiring the player's input information in which “tsundere” is input as a keyword, the character creation management unit 106 sets “tsundere”as the category.

When the acquired player's input information does not match a predetermined category, the character creation management unit 106 sets the category based on text information such as “keyword” inputted as user input information by referring to dictionary data for converting the player's input information into the category, the dictionary data being stored in advance in the game data storage unit 144.

On the other hand, when acquiring the text information, the image information, and the sound information stored in advance in the player information storage unit 146 as the player-related information as described above, the character creation management unit 106 executes the text analysis process, the image analysis process, or the sound analysis process on acquired player-related information, and acquires the information of the characteristic amount analyzed.

The character creation management unit 106 sets the category based on the acquired characteristic amount information by using the table data in which the characteristic amount and the category are associated with each other.

For example, in the case where detecting, from the image information, a characteristic amount of a female character whose clothes are unisex fashion, pants style, and simple design, the character creation management unit 106 sets “easygoing type” as the category with reference to the table data.

For example, when using the other-player-related information, the character creation management unit 106 sets, in the category, the characteristic (for example, purple coordinate) identical to the appearance of the player character of the other player or a characteristic (American casual) different from the appearance (trad style) of the player character of the other player.

### Determination of the Modified Composing Element

When the category is determined, the character creation management unit 106 specifies the modification selection composing element that can be used for modifying and for which the category is defined, as shown in FIG. 8, and reads out information (modification selection composing element information) of the specified modification selection composing element.

As shown in FIG. 8, the character creation management unit 106 determines a modification composing element from among the modification selection composing elements that can be used for modification, either randomly or by a specific algorithm.

Specifically, the character creation management unit 106 uses, as a specific algorithm, information of the composing element frequently used for each player or the entire player, an employment history (other player-related information) of each player, a modification strength, and a special note.

For example, when using the other player-related information, since the same characteristic (team color, etc.) as the appearance of the player character of the other player or a different characteristic (for creating a unique modified character) is the category, the character creation management unit 106 determines the modification composing element having the corresponding category from among the modification selection composing elements.

For example, when the creation history of the modified character is small, the character creation management unit 106 determines the modification composing element to be used for modification based on the above information such as determines a composing element having a modification strength of “1” as a modification composing element from among the modification selection composing elements, and determines the composing element having the largest number of employment history of the player as the modification composing element.

FIG. 8 shows an example in which, when “face” and “clothes” are specified as modification composing elements and “tsundere” is set as a category, a modification composing element corresponding to “face” and “clothes” and having a category of “tsundere” is specified from among a plurality of modification selection composing element information.

### Determination of Composing Elements to be Modified Based on Instructions of the Player

The character creation management unit 106 may determine the modification composing element of the base character to be modified based on an instruction from the player or an instruction from the program.

For example, in this case, when executing the character modification process, the character creation management unit 106 inquires of the player regarding the part of the composing element desired to be modified, and determines the composing element to be modified according to the instruction of the player.

### Expansion of the Composing Element to be Modified

When the input information reception process unit 105 detects, as the player situation, the charging history of the player or the game situation of the game played by the player, the character creation management unit 106 may determine the configurable composing elements based on the detected player situation.

That is, the character creation management unit 16 has a configuration of improving the motivation of the player for charging or the motivation of playing the game by increasing the change of the modified character, such as increasing the number of configurable composing elements (up to 10) according to the charge amount of the player or the depth of the game when setting only a small number (for example, three) of the composing elements at first.

Specifically, the character creation management unit 106 releases the modifiable composing element when a predetermined charge amount is exceeded or when a predetermined game task is cleared.

As shown in FIG. 8, the character creation management unit 106 determines the modification composing element information from among the composing elements that can be used for modification, either randomly or by a specific algorithm.

### [4-5] Character Modification Process

Next, the character modification process executed by the server 10 of the present embodiment will be described with reference to FIG. 8.

The character creation management unit 106 executes the modified character creation process of creating the modified character by modifying the composing elements from the base character based on the modified composing element determined as described above.

Specifically, as shown in FIG. 8, when the base character is specified by the player's instruction or automatically by the program, the character creation management unit 106 reads out the base character information from the character information storage unit 148.

The character creation management unit 106 creates the modified character based on the base character information and the information of the determined modification composing element.

At this time, the character creation management unit 106 may create the modified character by changing the contents of the composing elements of the base character, may change the composing element of the base character to modified composing element as it is, or may create the modified character by adding a new composing element to the base character, based on an instruction from the player or in accordance with a predetermined program.

The character creation management unit 106 may execute the modification for all the modifiable modification composing elements, or may create the modified character only for the modification composing element designated by the player.

FIG. 8 shows an example in which the modified character information is formed by modifying the modified composing elements specified for the face and the clothes of the base character.

### [4-5] Modified Character Registration Process

Next, the modified character registration process executed by the server 10 of the present embodiment will be described.

The character creation management unit 106 registers the information (that is, modified character information) of the created modified character as modified character information in the player-related information when creating the modified character by the character modification process.

Specifically, the character creation management unit 106 registers, as the modified character information, to the player-related information with the character ID as described above:
(A1) a base character ID of a modification source;
(A2) information of the unchanged composing element;
(A3) information of the modified composing element such as a part of the modified composing element and the composing element ID for specifying the composing element; and
(A4) creation and use history information such as creation date and time and use date and time of the modified character.

### [4-7] Information Providing Process

Next, the information providing process executed by the server 10 of the present embodiment will be described.

The information providing unit 111 generates various game information (information of the progress of the game) for the terminal device 20 to process the game, and provides the generated information to the terminal device 20.

Specifically, the information providing unit 111provides game information relating to the game in which the modified character appears to the terminal device 20 of a player having the modified character or a player having a predetermined relationship such as playing a game against the modified character, in accordance with an instruction from the player.

When the player desires to use the modified character in a virtual space other than the game, the information providing unit 111may provide the already registered modified character information to the corresponding terminal device 20 or another server (not shown) based on an instruction from the player.

### [4-8] Modified Example

### [4-8-1] First Modification: Automatic Creation of the Modified Character by the AI

Next, as a first modification of the present embodiment, a process of automatically creating the modified character by AI will be described.

In the above embodiment, the modified character is created by determining the composing element to be modified randomly or according to a predetermined algorithm. However, the modified character may be created by executing machine learning with training data in order to automatically create the modified character more matching the player's preference.

Specifically, the character creation management unit 106 executes a model data generation process of generating a modified character model (model data) using the input user related information or player's input information and a character model (may be provided from the outside or may be generated in advance) corresponding to the user related information or the player's input information as the training data.

The character creation management unit 106 executes the modified character creation process of automatically creating the modified character based on the input user related information or the player's input information by using the creating modified character model (model data).

It is preferable that the character creation management unit 106 inquires of the player whether the created modified character is employed or not before registering the modified character, and registers the modified character in the player-related information when the player indicates his/her intention to employ the modified character.

That is, in this way, by inquiring to the player whether or not to employ the modified character before the registration, the created modified character is evaluated, and the model data is improved based on the evaluation, whereby the modified character matching the preference of the player can be automatically created.

As the modified character model, a model may be generated for each player, for each attribute common to the attributes of the users, or a single model may be generated as a whole.

When the player's evaluation of the modified character created by the model data generation process cannot be obtained (that is, when the modified character is not employed by the player or when the modified character is not employed by the player for a predetermined number of consecutive times), the character creation management unit 106 may increase the number of modifiable composing elements to enhance the learning strength (modification strength) and modify the composing elements of the model data, as described later.

### [4-8-2] Modification Example 2: Modification Strength in the Modified Character Creation Process

Next, as a second modification of the present embodiment, the modification strength in the modified character creation process will be described.

In the modified character created in the above embodiment, when the player cannot evaluate the modified character, the number of modifiable composing elements may be increased to enhance the modification strength in the modified character creation process, for example, by changing the composing elements that have been prohibited to be modified to modifiable composing elements.

Specifically, the character creation management unit 106 sets the modification strength of the composing element based on the instruction of the program or the instruction of the player when a predetermined condition is satisfied.

The character creation management unit 106 creates the modified character by modifying the composing elements from the base character based on the set modification strength and the category.

For example, the character creation management unit 106 uses, as the predetermined condition, a condition that the modified character created by the player has not been employed (registered) or that the employment of the modified character has not been continued a predetermined number of times.

Then, the character creation management unit 106 sets the modification strength by increasing the number of modifiable composing elements based on the player's instruction or according to the predetermined algorithm, such as changing the composing element that has been prohibited to be modified to a modifiable composing element.

### [4-8-3] Third Modification: Arrangement of the Modified Character in the Virtual Space Based on a Given Event

Next, as a third modification of the present embodiment, the arrangement of the modified character in the virtual space based on a given event will be described.

In the modified character created in the above embodiment, when a given event occurs, the modified character created as described above may be placed in the virtual space in place of the base character or the player character designated by the player.

In other words, in this case, when a battle event of a game or the like is detected, a modified character specialized in a battle can be used.

Specifically, the game management unit 103 recognizes that the modified character is registered for a special purpose of use such as a fighting character (for example, a game against an enemy character), and when detecting execution of an event (for example, a game event) that matches the special purpose of use, arranges in the game space a modified character that is registered in the player-related information and that matches the special purpose of use, instead of or in addition to the player character that is the object of operation by the player in the current game space.

When the modified character is placed in the game space, the game management unit 103 controls the action and movement of the modified character in the game space based on the operation of the player received via the terminal device 20.

### [4-8-4] Modification Example 4: Arrangement of the Modified Character in the Virtual Space Based on a Given Condition

Next, as a fourth modification of the present embodiment, the arrangement of the modified character in the virtual space based on a given condition will be described.

In the modified character created in the above embodiment, when a given condition is satisfied, the modified character created as described above may be placed in the virtual space in place of the base character or the player character designated by the player.

In other words, in this case, the modified character can be used in the mini-game when performing a specific event such as the mini-game of the game is detected.

Specifically, when recognizing that the modified character is registered, and when detecting that a predetermined condition in the game, such as acquisition of a specific item, is satisfied, the game management unit 103 arranges the modified character instead of or in addition to the player character to be operated by the player in the current game space.

When the modified character is arranged in the game space, the game management unit 103 controls the action and movement of the modified character in the game space based on the operation of the player received via the terminal device 20.

In the present embodiment, the given condition may be set arbitrarily by the player.

### [4-8-5] Modification Example 5: Providing the Modified Character Information to the Other Players

Next, as a fifth modification of the present embodiment, providing the modified character information to another player will be described.

The modified character created in the above embodiment may be provided to another player character different from the created player character.

In other words, in this case, since the modified character can be created by using the composing elements of the other player based on the base character of the player himself/herself, the server 10 of the present modification has a configuration capable of taking in the taste of the preference of the other player into the base character of the player himself/herself.

Specifically, when recognizing that the modified character is registered, and when a predetermined condition such as permission or charge of the player is satisfied, the game management unit 103 provides the composing element information of the modified character information to other players as the composing element information for the modified character of the other player.

The character creation management unit 106 creates the modified character based on the base character of the player to which the composing element information for modified character of the other user is provided and the provided composing element information for the other user modified character, and registers the modified character in the player-related information.

Basically, in the other player to which the composing element information for the modified character of other user, since the base character of the player from which the composing element information for the modified character of the other user is provided is different, the character creation management unit 106 creates different modified characters even when the same composing element information is used.

### [4-8-6] Sixth Modification: Creation of Multiple Modified Characters

Next, as a sixth modification of the present embodiment, creation of a plurality of modified characters in the modified character creation process will be described.

In the above embodiment, in the modified character creation process, a plurality of modified characters may be created based on the player-related information.

Specifically, the server 10 has a configuration to:
(A1) manage information of the base character whose composing elements can be changed as base character information;
(A2) acquire player-related information (particularly, historical information relating to the player character) stored in the player information storage unit 146;
(A3) execute the modified character creation process for creating a plurality of modified characters in which the composing elements is modified from the base character based on the acquired player-related information; and
(A4) register the information of the created modified character as modified character information in the player information storage unit 146.

In particular, the character creation management unit 106 has a configuration to create the plurality of modified characters based on image information or sound information concerning the player's past characters such as a usage history of the player character or a contact history with another character.

### [5] Operation of the Present Embodiment

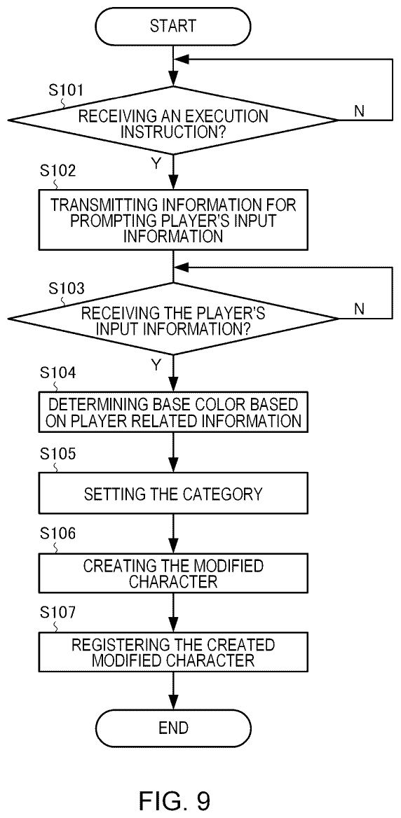

Next, the operation of the modified character creation and registration process executed by the server 10 of the present embodiment will be described with reference to FIG. 9.

FIG. 9 is a flowchart illustrating the operation of the modified character creation and registration process executed by the server 10 according to the present embodiment.

The present operation will be described with respect to a case where the modified character is created based on the category determined based on both player's input information input by a player and player-related information (information of the player character that was used in the past).

In this operation, it is assumed that the base character is set in advance, and the composing element that can be modified in association with each category is set in advance.

The present operation will be described with respect to the case where the parts of the composing elements to be modified are predetermined.

The present operation will be described with respect to the case where the game has already started, and the modified character creation and registration process is executed at a given timing based on an instruction from the player.

First, upon receiving an instruction to execute the player's modified character creation and registration process transmitted from the terminal device 20 (step 101), the game management unit 103 transmits information for prompting the player to input the player's input information to the corresponding terminal device 20 (step 102).

Next, when receiving the player's input information transmitted from the terminal device 20 (step 103), the game management unit 103 refers to the relevant player-related information, and refers to the information of the player character that was used in the past, and determines the color serving as the base color for composing the modified character (step 104).

Next, the character creation management unit 106 sets the category based on a keyword in the player's input information such as “tsundere” and a base color of “dark blue”(step 105).

Next, the character creation management unit 106 creates a modified character by modifying the corresponding composing element based on the set category (step 106).

Finally, the character creation management unit 106 registers the created modified character in the player-related information of the corresponding player (step 107), and terminates the present operation.

### [6] Other

The present embodiment is not limited to those in the above-described embodiments, and various modifications and variations can be made. For example, words cited as broadly or synonymously in the description or drawings may be replaced by broadly or synonymously in the description or drawings.

The present embodiment is not limited to those in the above-described embodiments, and various modifications and variations can be made. For example, words cited as broadly or synonymously in the description or drawings may be replaced by broadly or synonymously in the description or drawings.

In this embodiment, each game may be provided to the terminal device 20 by one server 10, or a server system may be constructed by linking a plurality of servers 10 and each game may be provided to the terminal device.

In addition, in the present embodiment, the game provided by the server 10 is executed by the terminal device 20, but the functions of the process unit 100 of the server 10 and the execution of the game program may be executed by the terminal device 20.

In addition, although the present embodiment has been described with reference to an example of the case where the present invention is applied to a game system, the present invention is not limited to this, and the present invention can be applied to a system (entertainment system) that provides various services realized in a virtual space using an avatar (character to be operated by a user) such as a metaverse, and a system that can be realized using a plurality of different virtual spaces.

The present embodiment includes substantially the same configuration as the configuration described in the embodiment (for example, the configuration with the same function, method and result, or a configuration with the same purpose and effect). The present embodiment also includes a configuration in which non-essential parts of the configuration described in the embodiment are replaced. The present embodiment also includes a configuration that achieves the same effects as the configuration described in the embodiment or a configuration that can achieve the same purpose. The embodiment also includes a configuration obtained by adding a known technique to the configuration described in the above embodiment.

Although the present embodiments have been described in detail as described above, it will be readily apparent to those skilled in the art that many variations are possible without departing materially from the new matter and effect of the present invention. Accordingly, all such modifications are intended to be within the scope of the present invention.

### REFERENCE SIGNS LIST

S Game System
10 Server
16 Character Creation Management Unit
20 Terminal Device
100 Process Unit
101 Communication Control Unit
102 Web Process Unit
103 Game Management Unit
104 Player Information Storage Unit
105 Input Information Reception Process Unit
106 Character Creation Management Unit
110 Timer Management Unit
111 Information Providing Process
120 Input Unit
130 Display Unit
140 Storage Unit
142 Main Storage Unit
144 Game Data Storage Unit
146 Player Information Storage Unit
148 Character Information Storage Unit
180 Information Storage Medium
196 Communication Unit
200 Process Unit
201 Input Receiving Unit
202 Game Process Unit
211 Web Browser
220 Drawing Unit
230 Sound Process Unit
260 Input Unit
262 Detection Unit
270 Storage Unit
271 Main Storage Unit
272 Image Buffer
280 Information Storage Medium
290 Display Unit
292 Sound Output Unit
296 Communication Unit

1. A character management system for managing a character used in a virtual space, comprising one or more processors and one or more memories, the processor programmed to:
manage, as base character information, information of a base character whose composing elements are changeable and which is stored in a storage unit for managing a character;
acquire user related information regarding a user or user input information including at least one of text information, image information, and voice information that are input by the user, the user related information having been already stored in a storage unit for user management;
a determine, based on an acquired user related information or an acquired user input information, the content of the composing element of the base character, a composing element to be changed from among the composing elements of the base character, or a composing element to be added to the base character; and
execute a modified character creation process of creating a modified character in which the composing element is modified from the base character based on the content of the determined composing element, the composing element to be modified, or the composing elements to be added.

2. A character management system for managing a character used in a virtual space, comprising one or more processors and one or more memories, the processor programmed to:
manage, as base character information, information of a base character whose composing elements are changeable and which is stored in a storage unit for managing a character;
acquire user related information regarding a user, the user related information having been already stored in a storage unit for user management;
execute a modified character creation process of creating a plurality of modified characters in which the composing element is modified from the base character based on an acquired user related information; and
present to the player information of a created modified character as modified character information.

3. The character management system according to claim wherein the processor is programmed to
select one or more the modified characters by the user from among the plurality of modified characters.

4. The character management system according to claim 1 wherein
related character history information that is information of a character, which was involved in the past, by the user or that is information of a user character owned by another user related to the user; or
virtual space history information relating to a virtual space in which the user character existed in the past.

5. The character management system according to claim 1, wherein
the user input information includes information of an appearance or a personality of the modified character.

6. The character management system according to claim 1, wherein the processor is programmed to:
execute model data generation process to generate, as model data, a modified character model based on training data including the input user related information or user input information and a character model corresponding to the user related information or the user input information, ; and
execute the modified character creation process of creating the modified character based on the input user related information or player's input information by using the generated model data.

7. The character management system according to claim 1, wherein the processor is programmed to
determine the composing element to be modified based on a given instruct, and executes the modification of a determined composing element.

8. The character management system according to claim 1, wherein the processor is programmed to:
detect occurrence of a given event; and
arrange the modified character in place of the character in use on the basis of the registered modified character information when the occurrence of the event is detected.

9. The character management system according to claim 1, wherein the processor is programmed to:
detect a given condition; and
arrange the modified character in place of the character in use on the basis of the registered modified character information when the condition is detected.

10. The character management system according to claim 1, wherein the processor is programmed to
detect a charging history of the user or a game situation of the game played by the user, as the user status, and
determine a configurable composing element based on the detected user status, and creates the modified character based on a determined composing element.

11. The character management system according to claim 1, wherein
the composing element includes at least one of an item equipped to the character, a parameter set to the character, and a sound related to the character.

12. The character management system according to claim 1, wherein the processor is programmed to
provide the information of a determined composing element to another user as composing element information for another user modified character, and
create, as the modified character creation process, the modified character by modifying the composing element of the base character of the user based on the composing element information for another user modified character.

13. The character management system according to claim 1, wherein the processor is programmed to
set a modification strength of the composing element based on a given instruction, and
create the modified character in which the composing element is modified from the base character based on the set modification strength.

14. A character management method for managing a character used in a virtual space by a computer, comprising:
managing, as base character information, information of a base character whose composing elements are changeable, and which is stored in a storage unit for managing a character;
acquiring user related information regarding a user or user input information including at least one of text information, image information, and voice information that are input by the user, the user related information having been already stored in a storage unit for user management;
determining, based on the acquired user related information or user input information, the content of the composing element of the base character, a composing element to be changed among the composing elements of the base character, or a composing element to be added to the base character;
executing a modified character creation process of creating a modified character in which the composing element is modified from the base character based on the content of the determined composing element, the composing element to be modified, or the composing elements to be added.

15. A character management method for managing a character used in a virtual space by a computer, comprising:
managing, as base character information, information of a base character whose composing elements are changeable, and which is stored in a storage unit for managing a character;
acquiring user related information regarding a user, the user related information having been already stored in a storage unit for user management;
executing a modified character creation process of creating a plurality of modified characters in which the composing element is modified from the base character based on an acquired user related information; and
presenting to the player information of a created modified character as modified character information.

16-17. (canceled)
